(19) United States
(12) Patent Application Publication
(10) Pub. No.: US 2011/0148352 A1
(43) Pub. Date: Jun. 23, 2011

(54) HOLDER FOR HOLDING AND CHARGING MOBILE PHONE AND BLUETOOTH EARSET

(76) Inventors: Yuhua Wang, Beijing (CN); Lun Chai, Hong Kong (CN)

(21) Appl. No.: 13/061,517

(22) PCT Filed: Aug. 20, 2009
(86) PCT No.: PCT/CN2009/000955

§ 371 Date: Feb. 28, 2011

(30) Foreign Application Priority Data
Sep. 12, 2008 (CN) 200820147146.9

(51) Int. Cl. H02J 7/00

(52) U.S. Cl. 320/108; 320/115; 320/137

(57) ABSTRACT

A holder for holding and charging a mobile phone and bluetooth earset includes phone holder and earset stand portions. The phone holder portion includes a back plate, left and right holding arms attached to the back plate, left and right extension arms, a bottom member and bottom legs. The earset stand portion includes an earset stand back plate, an earset stand bottom piece, rim plate, and holding device, the earset stand portion being attached to the left or right holding arm or the left or right extension arm thereof in an integral or split manner. The holder further includes a holding cavity in a back surface of the back plate, a plug to receive power from an automobile, and a converting device which converts the received power into a direct current for charging the mobile phone and bluetooth earset.

### FIELD OF THE INVENTION

The present invention relates to a holder which brings convenience for a mobile phone to be used in a motor vehicle, and specifically relates to an apparatus which can hold the mobile phone and a bluetooth earset coordinated with the mobile phone thereon conveniently and charge both of them simultaneously when the mobile phone and the bluetooth earset are used in an automobile (the motor vehicle) or a boat.

### BACKGROUND OF THE INVENTION

In the case that a mobile phone is used while an automobile is running, it will belong to a behavior offending the traffic regulations if the mobile phone is held by one hand and only another hand left is used to hold a steering wheel. As a result, a bluetooth earset (an earset in which wireless reception and transmission can be implemented within a short distance) is invented. A prior application CN200620149119 to the present invention of the same inventor has disclosed a holder for holding the mobile phone and the bluetooth earset which is put at a proper position in the automobile and which is, however, only able to charge the bluetooth earset but can not charge the mobile phone.

### SUMMARY OF THE INVENTION

An object of the present invention is to provide a holder for holding and charging a mobile phone and a bluetooth earset which has a double charging function and which comprises a phone holder portion and an earset stand portion, wherein the phone holder portion includes a back plate, a left holding arm and a right holding arm attached to the back plate, a left extension arm and a right extension arm which are extendable/retractable from/to the left and right holding arms in a front-rear direction respectively, and a bottom member and bottom legs, at least one of the left and right holding arms being drawable/retractable from/to the back plate in a left-right direction, the earset stand portion includes an earset stand back plate, an earset stand bottom piece, a rim plate for positioning a lower end of the bluetooth earset, and a holding device for positioning an upper end of the bluetooth earset, the earset stand portion being attached to the left or right holding arm or the left or right extension arm thereof in an integral or split manner, a holding cavity for fixing the whole holder is provided in a back surface of the back plate of the phone holder portion, and the holder also includes a plug used to receive power of 12/24 V DC (direct current power) (may also be 6˜36 V DC) from an automobile and a converting device which converts the received power of 12/24 V DC (may also be 6˜36 V DC) into a direct current power (generally 5 V DC, 1˜4 V DC or 6˜36 V DC is also possible) having a voltage suitable to charge the mobile phone and the bluetooth earset, the direct current power (generally 5 V DC, 1˜4 V DC or 6˜36 V DC is also possible) being divided into two ways connected to each other parallelly for charging the mobile phone and the bluetooth earset respectively.

According to the holder for holding and charging a mobile phone and a bluetooth earset of the present invention, wherein a conducting wire device for power in the way for charging the mobile phone has a plurality of forms, and the conducting wire device is provided on one end thereof with an output plug for leading out power from an output socket and is provided on the other end thereof with various input plugs suitable for mobile phones of different styles.

According to the holder for holding and charging a mobile phone and a bluetooth earset of the present invention, wherein power in the way for charging the mobile phone is led to a plug to be inserted directly into a charging socket of the mobile phone via a conducting wire provided inside plastics articles of the holder.

According to the holder for holding and charging a mobile phone and a bluetooth earset of the present invention, wherein the direct current power is divided into two ways connected to each other parallelly by a dispensing block, on one end of the dispensing block is provided an input plug inserted into an input socket which is provided in the bottom piece of the earset stand portion or in the back plate of the phone holder portion, and on the other end of the dispensing block are provided an input socket which has the direct current power with the voltage suitable to charge the mobile phone and the bluetooth earset and an output socket connected to the input socket parallelly into which an output plug on one end of a conducting wire device for charging the mobile phone or the bluetooth earset is to be inserted.

According to the holder for holding and charging a mobile phone and a bluetooth earset of the present invention, wherein the dispensing block is attached to the bottom piece of the earset stand portion or the back plate of the phone holder in a split manner, or the dispensing block is combined integrally with the bottom piece of the earset stand portion or the back plate of the phone holder portion in an integral manner.

According to the holder for holding and charging a mobile phone and a bluetooth earset of the present invention, wherein the bottom member of the phone holder portion together with the bottom legs thereof can be pulled out downward from the back plate and retracted upward.

According to the holder for holding and charging a mobile phone and a bluetooth earset of the present invention, wherein transverse slots are opened in the bottom member of the phone holder portion, and two bottom legs are inserted into the slots and can be moved in the left-right direction.

According to the holder for holding and charging a mobile phone and a bluetooth earset of the present invention, wherein the bottom legs protrude forward from the bottom member.

According to the holder for holding and charging a mobile phone and a bluetooth earset of the present invention, wherein vertical axles are provided in the bottom member, and the bottom legs capable of being rotated out and rotated back horizontally are held by the axles.

According to the holder for holding and charging a mobile phone and a bluetooth earset of the present invention, wherein the bottom member and the bottom legs of the back plate of the phone holder portion are combined into a fixed bottom plate, and a plug to be inserted directly into a charging socket of the mobile phone is provided on the bottom plate.

According to the holder for holding and charging a mobile phone and a bluetooth earset of the present invention, wherein a plug to be inserted directly into a charging socket of the mobile phone is provided on an inner side of the left or right holding arm or either of the extension arms thereof of the back plate of the phone holder portion.

According to the holder for holding and charging a mobile phone and a bluetooth earset of the present invention, wherein when the earset stand portion is attached to the left or right holding arm or the left or right extension arm thereof of the back plate of the phone holder portion in the split manner, a fixing head provided on the earset stand is inserted into a fixing cavity provided in either of the holding arms or either of the extension arms, and a pair of electrical sockets and a pair of electrical plugs used to lead power connecting are provided in the fixing head and the fixing cavity respectively.

According to the holder for holding and charging a mobile phone and a bluetooth earset of the present invention, wherein when the earset stand portion is attached to the left or right holding arm or the left or right extension arm thereof of the back plate of the phone holder portion in the split manner, an inserting plate with a trapezoidal cross-section is provided on a side surface of the earset stand, a receiving groove the shape and the size of which match with those of the inserting plate is provided in an outer surface of either of the holding arms or either of the extension arms, and a pair of electrical contacts capable of conducting power are provided on a surface facing outward of each of the inserting plate and the receiving groove, the shapes, the sizes and the positions of the two pairs of electrical contacts matching with each other.

According to the holder for holding and charging a mobile phone and a bluetooth earset of the present invention, wherein the holding device of the earset stand portion includes a holding opening and a spring holding clip.

According to the holder for holding and charging a mobile phone and a bluetooth earset of the present invention, wherein the mobile phone is charged in such a wireless manner that after power led out from the automobile is converted into the direct current power having the voltage suitable to charge the mobile phone and the bluetooth earset, power in the way for charging the mobile phone is led into the back plate of the phone holder portion thereby to be converted into an alternating current power by a converting device provided in the back plate, the converting device is connected to a primary coil wound outside a core portion on one end of a primary magnet in the back plate so that a magnetic flux is generated in the primary magnet, and the other end of the primary magnet is a plate portion with an enlarged sectional area which is kept close to an inner surface of a front wall of the back plate; in charging, an outer surface of a rear wall of the mobile phone is kept close to an outer surface of the front wall of the back plate, a secondary magnet in the mobile phone which is kept close to the rear wall of the mobile phone receives the magnetic flux so that a secondary coil wound outside a core portion of the secondary magnet is caused to generate alternating current power and then direct current power having the voltage suitable to charge the mobile phone is obtained by a rectifier in the mobile phone to charge the mobile phone.

According to the holder for holding and charging a mobile phone and a bluetooth earset of the present invention, wherein the plate portion with an enlarged sectional area located on the other end of the primary magnet has more than one core portion of the primary magnet, and more than one set of primary coils are wound around the core portions correspondingly.

According to the holder for holding and charging a mobile phone and a bluetooth earset of the present invention, wherein in addition to electrical contacts for charging, each of the plug and the socket has electrical contacts for information communication, in the meanwhile, a loud speaker for playing back the voice received in the mobile phone and a microphone for sending the voice of the user of the mobile phone are provided in the back plate of the phone holder portion.

According to the holder for holding and charging a mobile phone and a bluetooth earset of the present invention, wherein both of the loud speaker and the microphone are provided in locations near to an upper end of the back plate of the phone holder portion.

According to the holder for holding and charging a mobile phone and a bluetooth earset of the present invention, wherein the loud speaker and the microphone are provided in a lower portion of the back plate and in the bottom member of the phone holder portion respectively.

According to the holder for holding and charging a mobile phone and a bluetooth earset of the present invention, wherein in addition to electrical contacts for charging, each of the plug and the socket has electrical contacts for information communication, a socket to be connected to an audio power amplifier stage of the mobile phone and a microphone for sending the voice of the user of the mobile phone are provided in the back plate of the phone holder portion, and music information stored in the local mobile phone or the voice of the counterpart of the talk received by the local mobile phone or music information stored in the mobile phone of the counterpart of the talk is led to an audio power amplifier stage of an audio equipment in the automobile via the socket in the wired manner and played back by a loud speaker in the automobile; a FM transmitter and a microphone for sending the voice of the user of the mobile phone may be provided in the back plate of the phone holder portion, and music information stored in the local mobile phone or the voice of the counterpart of the talk received by the local mobile phone or music information stored in the mobile phone of the counterpart of the talk is transmitted out in a wireless FM manner, received by the audio equipment in the automobile in a short distance and played back by the loud speaker in the automobile.

According to the holder for holding and charging a mobile phone and a bluetooth earset of the present invention, wherein the loud speaker for playing back the voice received in the mobile phone, the microphone for sending the voice of the user of the mobile phone, the socket to be connected to an audio power amplifier stage of the mobile phone, and the FM transmitter are provided in the back plate of the phone holder portion all at once collectively.

According to the holder for holding and charging a mobile phone and a bluetooth earset of the present invention, wherein the loud speaker for playing back the voice received in the mobile phone and/or the socket to be connected to an audio power amplifier stage of the mobile phone and/or the FM transmitter and the microphone for sending the voice of the user of the mobile phone are provided in locations near to an upper end of the back plate of the phone holder portion.

According to the holder for holding and charging a mobile phone and a bluetooth earset of the present invention, wherein the loud speaker for playing back the voice received in the mobile phone and/or the socket to be connected to an audio power amplifier stage of the mobile phone and/or the FM transmitter and the microphone for sending the voice of the user of the mobile phone are provided in a lower portion of the back plate and the bottom member of the phone holder portion respectively.

According to the holder for holding and charging a mobile phone and a bluetooth earset of the present invention, wherein the holder is attached with a fixing plate which fixes the whole holder to blades of an air outlet of an air conditioner in the automobile, the fixing plate is provided with a fixing button to be matchable with the holding cavity in the back surface of the back plate of the phone holder portion and a slot with a certain length and a pair of fixing clips are provided to the slot, said clips are movable along and rotatable in the slot.

According to the holder for holding and charging a mobile phone and a bluetooth earset of the present invention, wherein the holder is attached with a ball-socket universal joint type fixing device which fixes the whole holder to a proper surface in the automobile, the fixing device has a base plate on one side of which a double sided adhesive tape is stuck and on the other side of which a ball of a universal joint and a socket fitted in an embedded manner with the ball are provided, and the base plate is provided with standby holes for screw fixation or tie fastening, the socket being formed integrally with a front fixing plate, a fixing button to be matchable with the holding cavity in the back surface of the back plate of the phone holder portion being provided on a surface facing outward of the front fixing plate.

According to the holder for holding and charging a mobile phone and a bluetooth earset of the present invention, wherein the holder is attached with a suction cup type fixing device which fixes the whole holder to a glass surface or other smooth surfaces in the automobile, and the fixing device has a base shell, a suction cup sheet made of soft plastics, a pulling bar, a raising lever, a corrugated tube (stem), and a front fixing plate, a fixing button to be matchable with the holding cavity in the back surface of the back plate of the phone holder portion being provided on a surface facing outward of the front fixing plate.

According to the holder for holding and charging a mobile phone and a bluetooth earset of the present invention, wherein a round recess or a round raised disk is fabricated in/on the back surface of the back plate of the phone holder portion, and a round disk the size and the shape of which match with those of the round recess or the raised disk is seized in the round recess or fitted with the raised disk in a sliding-fitted-in assembling manner or a screw assembling manner; the round disk can be rotated with respect to the round recess or the raised disk without escape, and the holding cavity in the back surface of the back plate of the phone holder portion is provided in an outer surface of the round disk.

According to the holder for holding and charging a mobile phone and a bluetooth earset of the present invention, wherein a device constituted by the round recess or the raised disk and the round disk is provided with a set of stop spots for limiting an angle by which the round disk is rotated with respect to the round recess or the raised disk.

According to the holder for holding and charging a mobile phone and a bluetooth earset of the present invention, wherein the set of stop spots for limiting the rotation angle of the device constituted by the round recess and the round disk are formed in such a manner that two stop tabs and a number of recessed spots are provided at an edge of the round recess and on the periphery of the round disk is provided one protruding tab under which one protruding spot is provided.

According to the holder for holding and charging a mobile phone and a bluetooth earset of the present invention, wherein the set of stop spots for limiting the rotation angle of the device constituted by the raised disk and the round disk are formed in such a manner that a number of radial recessed grooves are provided along the circumference of the raised disk, on an inner surface of the round disk is provided one raised slab which coincides with a diameter of the round disk and the shape and the size of which match with those of the recessed grooves, and in a central portion of each of the raised disk and the round disk is provided a screw hole through which both of them can be fastened together by a screw.

According to the holder for holding and charging a mobile phone and a bluetooth earset of the present invention, wherein an upper stopping bar which is drawable and retractable in an up-down direction is provided at the top of the back plate of the phone holder portion for fixing the mobile phone held in the holder, and vertical axles and upper stopping tabs which are held by the axles and can be rotated out and rotated back horizontally are provided at positions near to both ends of the upper stopping bar.

According to the holder for holding and charging a mobile phone and a bluetooth earset of the present invention, wherein the back plate of the phone holder portion is opened with a center hole with inner threads which extends through the back plate, the center hole is provided with a recess portion with an enlarged section at a location near to the back surface of the back plate, a compensating plate opened with a stepped hole is provided in front of the back plate, and a front forcing screw which has outer threads to be fitted with the inner threads is screwed into the center hole; the front forcing screw is provided with a center tip with a radial recess on a front end thereof and a manual knob on a rear end thereof, the manual knob is provided with a linear/cross groove facing outward to receive a screw driver, and the radial recess of the center tip and the stepped hole of the compensating plate match with a fixing key.

According to the holder for holding and charging a mobile phone and a bluetooth earset of the present invention, wherein the loud speaker and the microphone are provided in locations near to an upper end of the back plate and in the bottom member of the phone holder portion respectively.

In the present invention, the holder which not only can hold the mobile phone and the bluetooth earset in a vehicle (or a small sized boat) conveniently but also can charge both of them and which serves for a driver of the vehicle further is designed. The holder of the invention has a simple structure and can be used conveniently.

### BRIEF DESCRIPTION OF THE DRAWINGS

FIGS. 1(a) to 1(f) are schematic diagrams of a holder according to a first embodiment of the present invention.

FIGS. 2(a) to 2(d) are schematic diagrams of a bluetooth earset coordinated with the holder (and a mobile phone to be held on the holder) of the present invention.

FIGS. 3(a) to 3(c) are schematic diagrams showing a state where the mobile phone and the bluetooth earset are held on the holder and electrical connections concerning the state in the holder according to the first embodiment of the present invention.

FIGS. 4(a) and 4(b) are schematic diagrams of an alternative mode of the first embodiment of the present invention.

FIGS. 5(a) to 5(c) are schematic diagrams of a second embodiment of the present invention.

FIGS. 6(a) and 6(b) are schematic diagrams of a third embodiment of the present invention.

FIGS. 7(a) and 7(b) are schematic diagrams of an alternative mode of the third embodiment of the present invention.

FIGS. 8(a) to 8(c) are schematic diagrams of a fourth embodiment of the present invention.

FIG. 9 is a schematic diagram of a fifth embodiment of the present invention.

FIG. 10 is a schematic diagram of a sixth embodiment of the present invention.

FIGS. 11(a) and 11(b) are schematic diagrams of a fixing plate for fixing the holder of the present invention to blades of an air outlet of air conditioner in an automobile.

FIG. 12(a) is a schematic diagram of a ball-socket universal joint type fixing device for fixing the holder of the present invention into the automobile, and FIG. 12(b) is a K-K sectional view in FIG. 12(a).

FIG. 13 is a schematic diagram of a suction cup type fixing device for fixing the holder of the present invention into the automobile.

FIGS. 14(a) to 14(h) are schematic diagrams of alternative modes of back configurations of a phone holder portion of the holder of the present invention.

FIGS. 15(a) and 15(b) are schematic diagrams of another alternative mode of the holder of the present invention.

FIGS. 16(a) to 16(e) are schematic diagrams of further alternative modes of the holder of the present invention.

FIG. 17 is a schematic diagram of still further another alternative mode of the holder of the present invention.

### DETAILED DESCRIPTION OF THE PREFERRED EMBODIMENTS

### First Embodiment

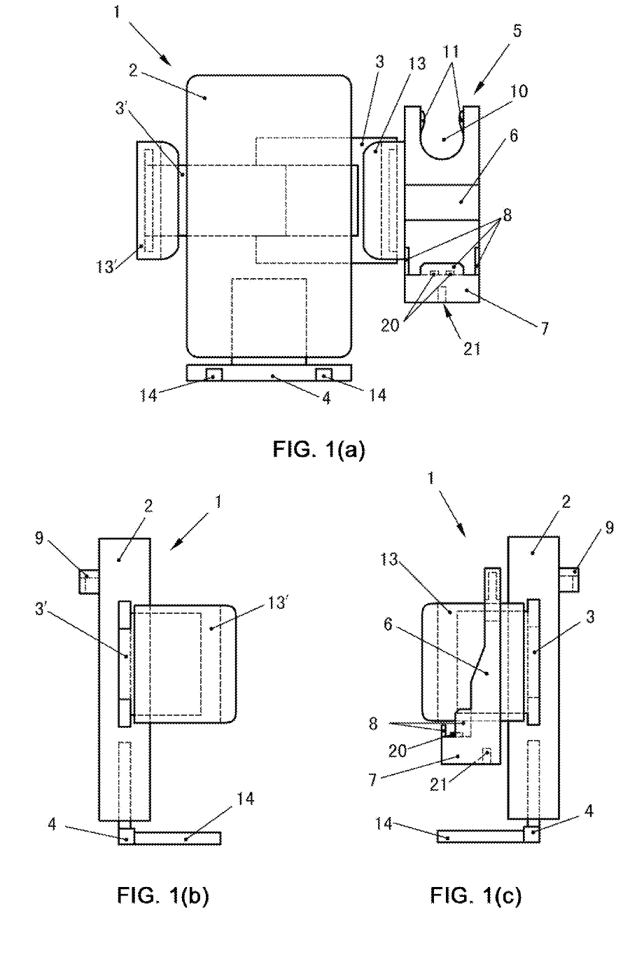

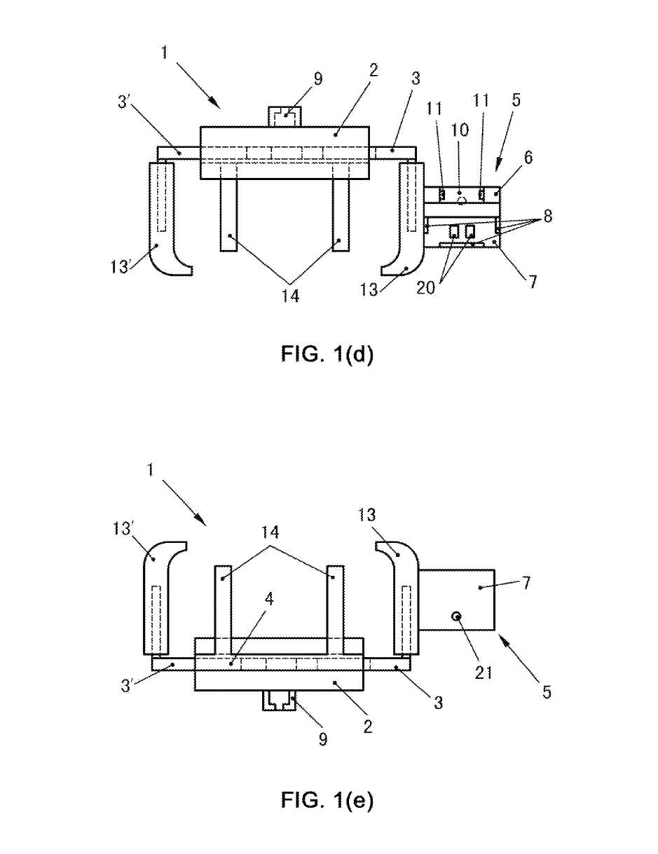

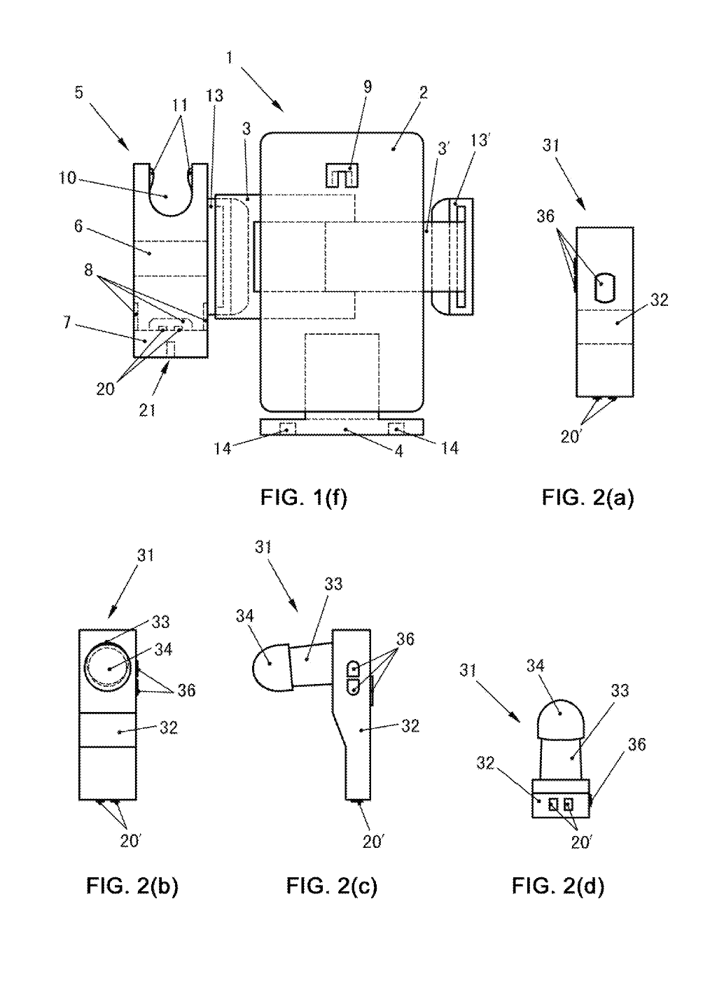

FIG. 1(a) is a front view of a holder 1 for holding and charging a mobile phone and a bluetooth earset of the present invention, FIG. 1(b) is a left side view of the holder 1, FIG. 1(c) is a right side view of the holder 1, FIG. 1(d) is a top view of the holder 1, FIG. 1(e) is a bottom view of the holder 1, and FIG. 1(f) is a rear view of the holder 1. A reference numeral 2 in these figures denotes a back plate of a phone holder portion of the holder 1, and the back plate is generally a plate molded from plastics (may be made of other materials) which has a certain thickness and is hollow. Reference numerals 3 and 3′ denote a right holding arm and a left holding arm respectively, and reference numerals 13 and 13′ denote a right extension arm and a left extension arm which can be extended/retracted from/to each of the holding arms in a front-rear direction, respectively. As seen from the figures, both of the right and left holding arms 3 and 3′ can be pulled out/retracted in a left-right direction from/to a space within the back plate thereby to regulate and fit a width of the mobile phone held therein. In practical use, at least one of the two holding arms should be drawable and retractable in the left-right direction in order to accommodate to the width of the mobile phone. The right extension arm 13 and the left extension arm 13′ are nested outside the right and left holding arms 3 and 3′ respectively, and the right and left extension arms 13 and 13′ can be pulled out and retracted in the front-rear direction to accommodate to a thickness of the held mobile phone. A bottom member denoted by reference numeral 4 with two bottom legs 14 (one or more than two bottom legs 14 are also possible, for example 1˜10 bottom legs, not shown) protruding forward are provided on a lower end side of the back plate 2, said bottom legs 14 are positioned near to both ends of the bottom member 4 to bear and support the mobile phone. The bottom member 4 shown in the figures together with the bottom legs 14 thereof can be pulled out from the bottom of the back plate 2 and retracted in an up-down direction to accommodate to a height of the held mobile phone. However, the mobile phone can be held as well even if the bottom member 4 along with its bottom legs 14 can not be pulled out and retracted in the up-down direction. Nevertheless, when there is an input socket in a side surface of the mobile phone, it will be convenient for use if the bottom member 4 can be used to regulate a height in the up-down direction so that the input socket is not shielded by the right or left extension arm 13 or 13′ (the mode in which the function of being pulled out and retracted in the up-down direction is not shown).

Furthermore, in addition to the mode in which the bottom legs protrude forward from the bottom member fixedly, the bottom legs may also be made so that they can be turned to protrude forward in a used state and can be turned to be retracted in a non-used state. That is, vertical axles are provided in the bottom member, and the bottom legs capable of being rotated out and rotated back horizontally are held by the axles (this configuration is not shown).

A reference numeral 5 in the figures denotes an earset stand for holding the bluetooth earset (an earset in which wireless reception and transmission can be implemented within a short distance), and the earset stand 5 has an earset stand back plate 6, an earset stand bottom piece 7, a rim plate 8 (here, it includes three small plates, however, other configurations are also possible but are not shown) provided for fixing a lower end of the bluetooth earset, and a holding device for holding an upper portion of the bluetooth earset. The holding device shown in FIG. 1 includes a holding opening 10 and a spring holding clip 11 which is provided on an inner side of the holding opening 10. The holding device may have a variety of forms which are not shown in the figures one by one. On the earset stand bottom piece 7 are provided a pair of electrical contacts 20 for charging the bluetooth earset, the configuration and the position of which should match with those of a pair of electrical contacts 20′ on a bottom end of the bluetooth earset to be held. At the bottom of the earset stand bottom piece 7 is provided an input socket 21 for leading in direct current power (generally 5 V DC, 1˜4 V DC or 6˜36 V DC is also possible) having a voltage suitable to charge the mobile phone and the bluetooth earset. In a back surface of the back plate of the phone holder portion is provided a holding cavity 9 for fixing the whole apparatus at a proper position in an automobile.

Needless to say, FIGS. 1(a) to 1(f) show that the earset stand 5 is attached to the right holding arm 3 (actually, it can be attached to the right extension arm 13 of the right holding arm 3), however, the earset stand 5 may also be designed to be attached to the left holding arm 3′ (or the left extension arm 13′ thereof), which is not shown.

FIG. 2(a) is a back view (showing the side opposite to an earphone) of the bluetooth earset 31 (in which wireless reception and transmission can be implemented within a short distance) coordinated with the holder 1 for holding and charging the mobile phone and the bluetooth earset of the invention, FIG. 2(b) is a front view, FIG. 2(c) is a side view, and FIG. 2(d) is a bottom view. A reference numeral 32 in the figures denotes a main body of the bluetooth earset 31, a numeral 33 denotes an earphone neck, a numeral 34 denotes an earphone tip, a numeral 36 denotes operating buttons (here is an exemplary illustration, and the number, position and shape of the operating buttons can be different in practical manufacture), and a numeral 20′ denotes a pair of electrical contacts which are provided at the bottom of the main body 32 of the bluetooth earset 31 for charging a battery in the main body 32. The shape and the size of the bluetooth earset 31 are required to match with those of the above-described earset stand 5. Herein, only one representative shape is shown in the figures, but the shape and the size of both of them can be changed in accordance with different designs.

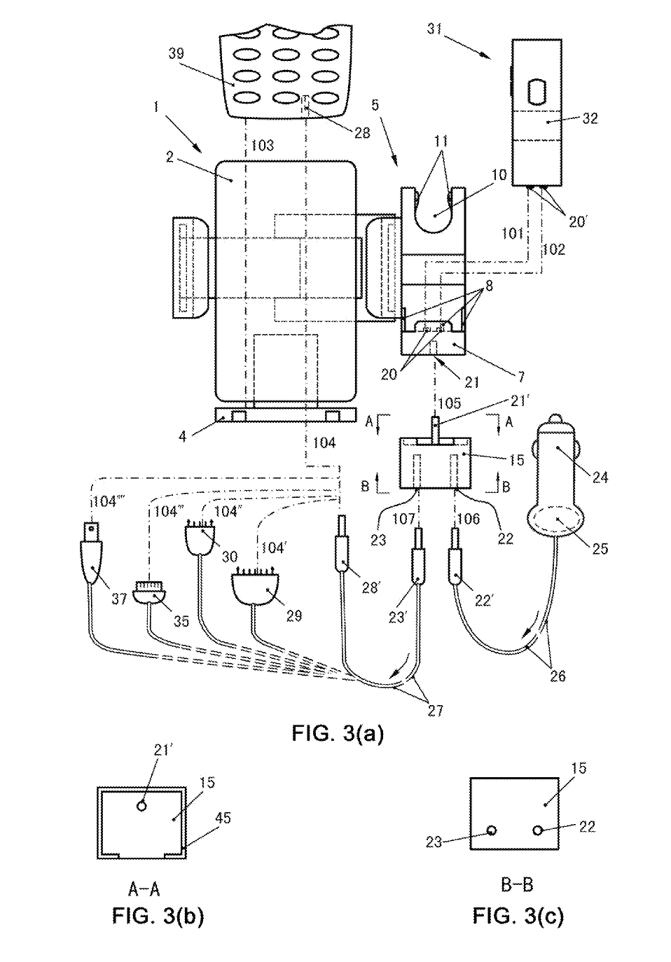

FIG. 3(a) is a schematic diagram of the arrangement and connection of the holder 1 for holding and charging the mobile phone and the bluetooth earset of the invention in the used state. A reference numeral 24 denotes a power plug used to be inserted into a power socket of 12/24 V DC (may also be other voltage) in the automobile so as to lead out the power. A reference numeral 25 denotes an electrical converting device provided in the power plug (the electrical converting device may not be provided in the power plug but provided separately, not shown), and the electrical converting device 25 converts the power of 12/24 V DC (may also be other voltage) into the direct current power (generally 5 V DC, other voltage is also possible) having the voltage suitable to charge the mobile phone and the bluetooth earset for charging the bluetooth earset 31 and the mobile phone 39. The direct current power having the voltage suitable to charge the mobile phone and the bluetooth earset is led to an input plug 22′ via a conducting wire 26, the input plug 22′ is inserted into an input socket 22 on a lower end of a dispensing block 15 as shown by a dot-dash line 106, and an input plug 21′ on an upper end of the dispensing block 15 is inserted into the input socket 21 at the bottom of the earset stand bottom piece 7 located on the lower end of the earset stand 5 as shown by a dot-dash line 105. The bluetooth earset 31 is put in the earset stand 5 as shown by dot-dash lines 101 and 102 so that a lower end of the bluetooth earset 31 is seated within a space surrounded by the three rim plates 8. At the same time, the pair of electrical contacts 20′ for charging on the lower end of the bluetooth earset 31 are connected to the pair of electrical contacts 20 on the earset stand bottom piece 7 so that the battery in the bluetooth earset is charged. In the meanwhile, the earphone neck 33 of the bluetooth earset 31 is put in the holding opening 10 to be held by the spring holding clip 11 so that the bluetooth earset 31 is fixed.

On the other hand, an output plug 23′ is inserted into an output socket 23 as shown by a dot-dash line 107, the output socket 23 is provided at the bottom of the dispensing block 15 and is electrically connected to the input socket 22 parallelly, and has the direct current power with the voltage suitable to charge the mobile phone and the bluetooth earset, so that the direct current power having the voltage suitable to charge the mobile phone and the bluetooth earset is led into an input socket 28 at the bottom of the mobile phone 39 via a conducting wire 27 and an input plug 28′ as shown by a dot-dash line 104 to charge the mobile phone 39. The mobile phone 39 is put on the bottom member 4 (and the bottom legs 14 thereof) of the phone holder 1 as shown by a dot-dash line 103, in the meantime, the mobile phone 39 can be held tightly by the left and right holding arms so that it can be fixed.

Mobile phones available in the market have various styles, so the input sockets for charging thereof have different forms as well. The input plug 28′ and the input socket 28 described above are cylindrical/round hole shaped, however, the input socket 28 may have a variety of alternative forms (not shown one by one and omitted) according to different requirements for the mobile phones. Correspondingly, the input plug 28′ can be modified into such forms as indicated by reference numerals 29 and 30 (in-line multiple plugs), 35 and 37 and be inserted into the mobile phone 39 as shown by dot-dash lines 104′, 104″, 104′″, 104″″ and the like respectively. Certainly, other plug forms are also possible, but examples thereof are omitted here.

There may be another alternative form, that is, a charging socket of the mobile phone may not be provided at the bottom of the mobile phone but on the left side or the right side thereof, accordingly, each of the input plugs 28′, 29 and the like is to be inserted from a side portion of the mobile phone. On this occasion, it is possible that the input socket is shielded by the left or right holding arm (or the left or right extension arm) of the phone holder, but this problem can be solved by exposing the input socket by use of the function of the bottom member 4 and the bottom legs 14 capable of being adjustable up and down.

FIGS. 3(b) and 3(c) are an A-A top view and a B-B bottom view of the dispensing block 15 respectively. A reference numeral 45 in FIG. 3(b) denotes a rim on an upper end of the dispensing block 15, and the rim 45 is used to embrace and hold the bottom piece 7 at the bottom of the earset stand 5 to fix it there. Other reference numerals in FIGS. 3(a) to 3(c) denote the same components as those described above.

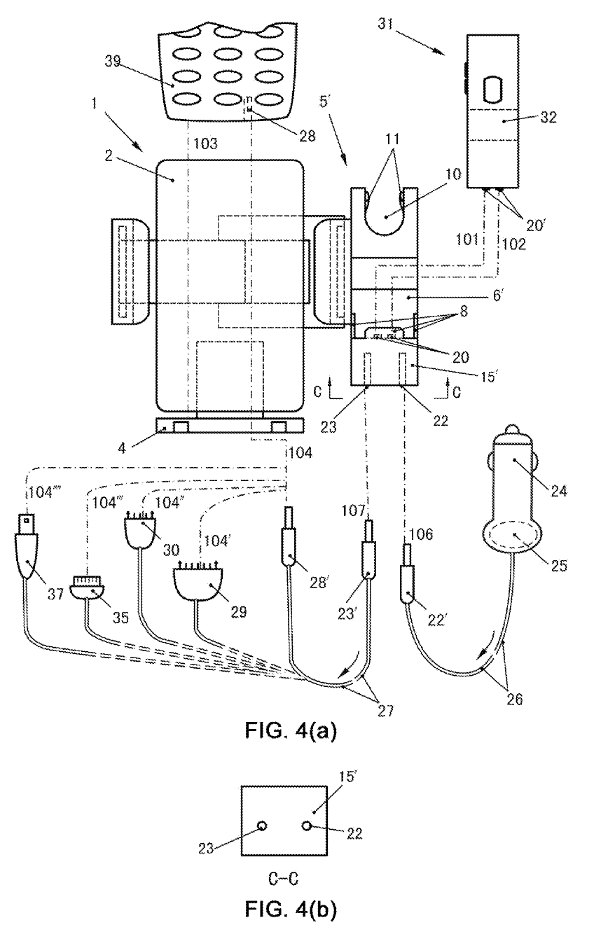

FIG. 4(a) shows an alternative mode of the present embodiment. The dispensing block 15 described above in FIGS. 3(a) to 3(c) is a split type, that is, the dispensing block 15 can be separated from the earset stand bottom piece 7 at the bottom of the earset stand 5. The input plug 21′ of the dispensing block 15 is inserted into the input socket 21 of the earset stand bottom piece 7 while the rim 45 embraces and holds the bottom piece 7 to fix it.

This alternative mode shown in FIG. 4(a) is to combine the dispensing block 15 and the earset stand bottom piece 7 integrally into a dispensing block 15′. Other parts in FIG. 4(a) are the same as those in FIG. 3(a) except that the earset stand 5 is changed into 5′ and the back plate 6 is changed into 6′, and the repeated description thereof is omitted. FIG. 4(b) is a C-C bottom view of the dispensing block 15′ in FIG. 4(a), and other reference numerals in FIGS. 4(a) and 4(b) denote the same components as those described above.

The dispensing blocks 15 and 15′ shown in FIGS. 3(a) and 4(a) are connected to the lower ends of the earset stands 5 and 5′ respectively, however, they may be connected to an appropriate location of the back plate 2 (or 2′, 2″, 49, 50, 50′) of the phone holder portion, especially for the following cases shown in FIGS. 6 to 10 (these alternative modes are not shown).

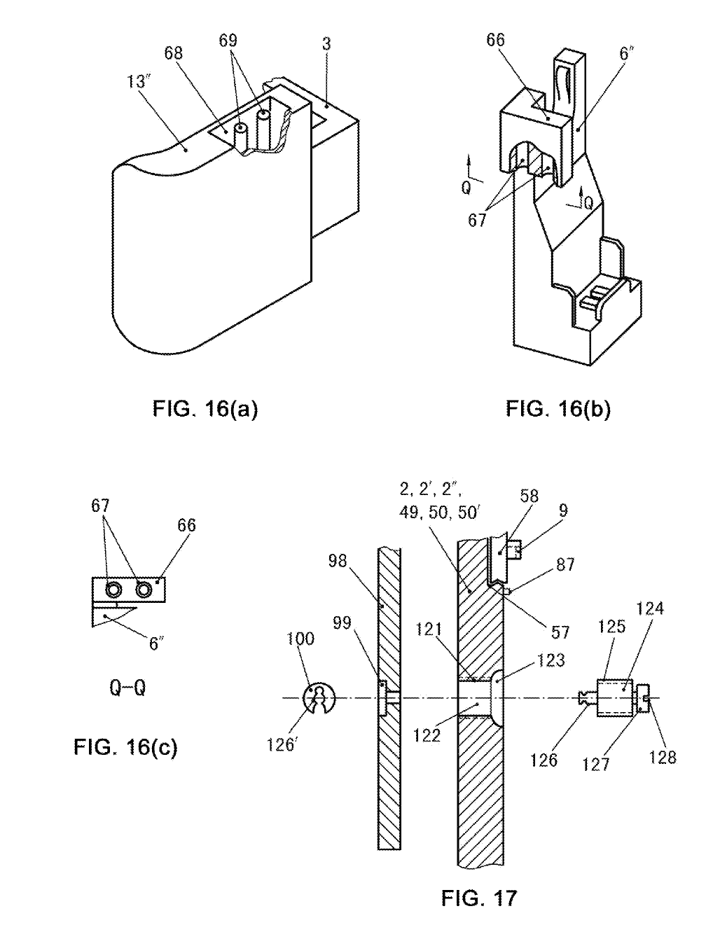

FIGS. 16(a) to 16(c) show another alternative mode of the present embodiment, that is, the earset stand is attached to a left extension arm 13″ (or the right holding arm 3, or the left holding arm 3′, or the right extension arm 13, not shown) in a split manner. A fixing head 66 is provided on an earset stand back plate 6″, a fixing cavity 68 is provided in the left extension arm 13″, and the fixing head 66 is inserted into the fixing cavity 68 so that the earset stand can be attached to the left extension arm 13″. A pair of electrical sockets 67 and a pair of electrical plugs 69 are provided in the fixing head 66 and the fixing cavity 68 respectively for electrically connecting the earset stand and the phone holder portion (through interiors of plastics articles). When the fixing head 66 is inserted into the fixing cavity 68, the electrical plugs 69 are inserted into the electrical sockets 67 simultaneously so that both of them are electrically connected. FIG. 16(c) is a Q-Q view in FIG. 16(b).

FIGS. 16(d) and 16(e) show another alternative mode of the present embodiment, that is, the earset stand is attached to a left extension arm 13′″ (or the right holding arm 3, or the left holding arm 3′, or the right extension arm 13, not shown) in a split manner. On a side surface of an earset stand back plate 6′″ is provided an inserting plate 130, the cross section of which is a trapezoid with a long bottom side facing outward. In the meanwhile, in the left extension arm 13′″ (or the right holding arm 3, or the left holding arm 3′, or the right extension arm 13, not shown) is provided a receiving groove 131. The position, the shape and the size of receiving groove 131 match with those of the inserting plate 130. The inserting plate 130 can be inserted (by sliding) into the receiving groove 131 so that the earset stand is attached to a holding arm (or an extension arm). A pair of electrical contacts 20″ and a pair of electrical contacts 20′″ are provided on surfaces facing outward of the inserting plate 130 and the receiving groove 131 respectively, and the shape, the size and the position of the electrical contacts 20″ and those of the electrical contacts 20′″ match with each other. When the inserting plate 130 is inserted into the receiving groove 131, both of them can be electrically connected (through interiors of plastics articles).

### Second Embodiment

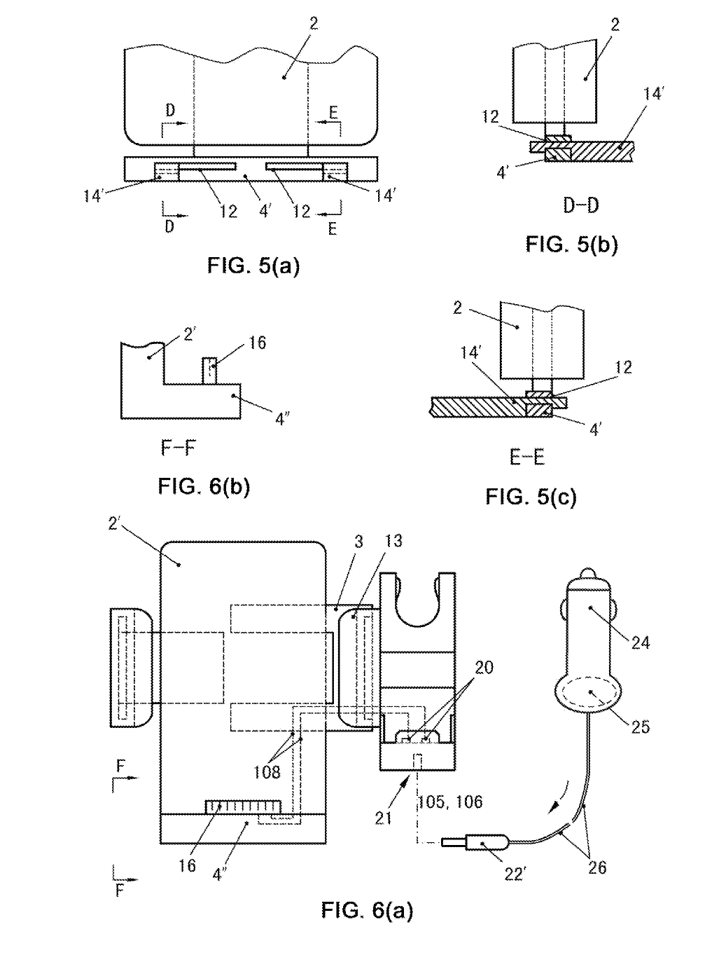

The present embodiment differs from the first embodiment described above only in terms of the bottom member of the phone holder portion. As shown in FIG. 5(a), slots 12 are provided in a bottom member 4′ on the lower end side of the back plate 2, and bottom legs 14′ are inserted into the slots 12 and can be moved horizontally in the left-right direction with the effect that in case a position at which the input socket 28 provided on the lower end of the mobile phone is shielded by the bottom legs 14 (see FIGS. 1(a) to 1(f) and 3(a) or 4(a)), the bottom legs 14′ can be moved in the left-right direction to expose the input socket 28 so that the charging can be carried out. FIGS. 5(b) and 5(c) are a D-D sectional view and an E-E sectional view in FIG. 5(a) respectively, which show a connecting relationship among the bottom legs 14′, the slots 12, and the bottom member 4′ and in which other reference numerals denote the same components as those described above. As a matter of course, the configuration of the present embodiment is not necessarily consistent with that shown in the figures fully, and other configurations are also possible as long as the bottom legs 14′ can be attached and can be moved in the left-right direction (not shown).

### Third Embodiment

With rapid development of mobile phones, the functions concurrently possessed by the mobile phones are increased progressively. For example, among a series of products such as iPhone, iPod and the like of Apple Inc., some concurrently possess the function of storing a music program, and others concurrently possess the functions of television reception and satellite navigation, and so on. Most of the input sockets of such mobile phones are multiple electrical contacts arranged in a line (referred to as input in-line multiple socket). In the present embodiment, as shown in FIG. 6(a), the bottom member 4 and the bottom legs 14 are changed by combining both of them into a bottom plate 4″ which is a horizontally laid flat plate substantially and the back plate 2 is changed into a back plate 2′. In FIG. 6(a), an input plug 16 (may be referred to as input in-line multiple plug) facing upward is provided on the bottom plate 4″. In order to supply power to the in-line multiple plugs 16 (at this time, the above mentioned dispensing block 15 or 15′ is not necessary), the power led to the input socket 21 is fed to the pair of electrical contacts 20 for charging the bluetooth earset in one way and is fed to the in-line multiple plug 16 via the conducting wire (as shown by dotted lines 108) provided inside the plastics articles of the holder in the other way connected to the one way parallelly. Thus, the right holding arm 3 and the right extension arm 13 may not be made to be drawable and retractable, but be made into a fixed right holding arm and a fixed right extension arm so that the conducting wire can pass through inside the plastics articles expediently (not shown). Other reference numerals in FIG. 6(a) denote the same components as those described above.

FIG. 6(b) is a F-F view in FIG. 6(a) showing the input in-line multiple plug 16 facing upward.

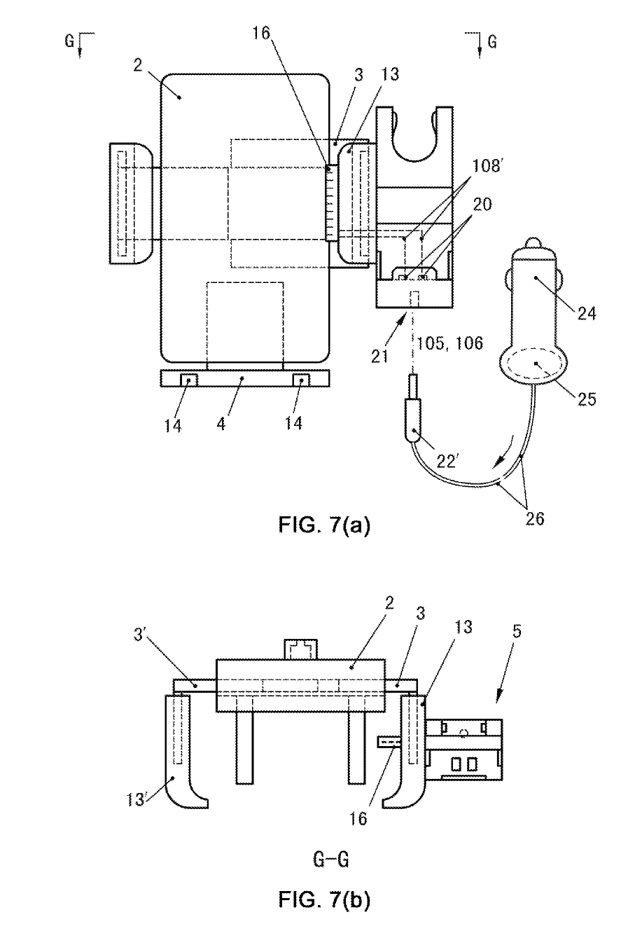

FIG. 7(a) shows another alternative mode of the present embodiment. When the input in-line multiple socket of the mobile phone to be served is not provided at the bottom of the phone but on a side of the phone, the bottom member 4 and the bottom legs 14 need not to be changed while the input in-line multiple plug 16 is fabricated on an inner side of the right extension arm 13 so as to be connected to the mobile phone. Likewise, the input in-line multiple plug 16 can be provided on an inner side of the left extension arm 13′ to correspond to the arrangement of the mobile phone to be served (this alternative mode is not shown). Power is led to the in-line multiple plug 16 through the interior of the plastics articles as shown by dotted lines 108′. FIG. 7(b) is a G-G view in FIG. 7(a) showing the configuration in FIG. 7(a) further, and other reference numerals in FIGS. 7(a) and 7(b) denote the same components as those described above.

In the first embodiment or the second embodiment shown and described above, the dispensing block 15 is connected to the earset stand 5 under the earset stand 5 (or the dispensing block 15′ is located under the earset stand 5′ in such a manner as to be integral with the earset stand 5′). In the third embodiment, in addition to the above described modes which can be continued, the dispensing block 15 can be made to be inserted into the back plate 2 (or 2′, 2″, 49, 50, 50′) of the phone holder portion at a proper position of the back plate 2, or the dispensing block 15′ can be made to be integral with the back plate 2 (or 2′, 2″, 49, 50, 50′) at a proper position of the back plate 2 (this alternative mode is not shown).

### Fourth Embodiment

In the first, the second and the third embodiments described above, when the mobile phone is held in the phone holder portion, the charging is achieved in a wired manner by inserting the input plug (or the in-line multiple plug) into the input socket (or the in-line multiple socket) of the mobile phone. The present embodiment is characterized in that the charging is realized in a wireless manner.

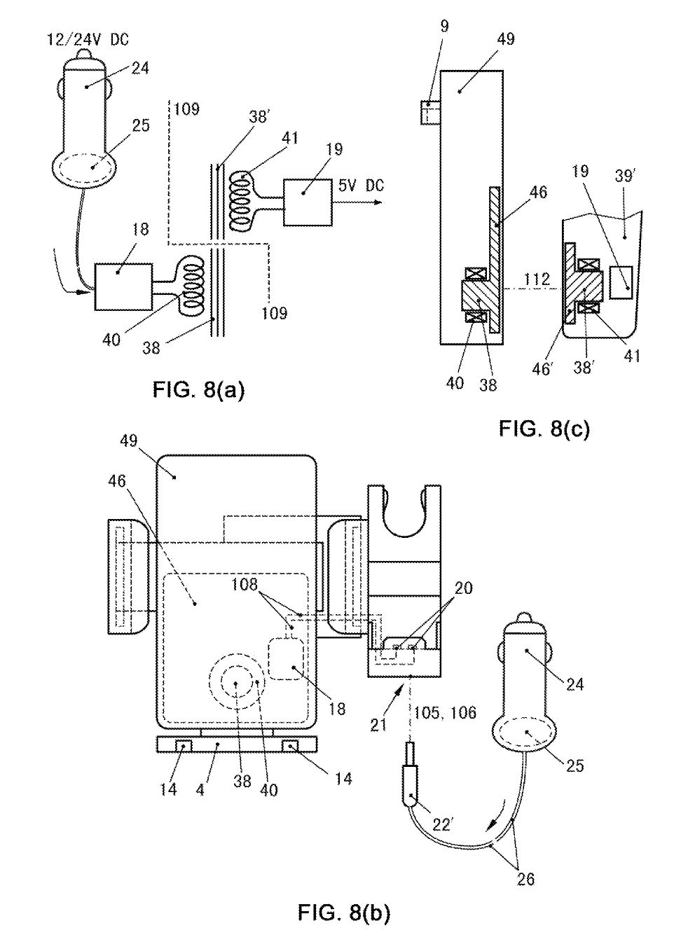

FIG. 8(a) is a principle diagram showing that the mobile phone is charged in a wireless manner. FIGS. 8(b) and 8(c) are schematic diagrams. Power of 12/24 V DC (may also be other voltage) obtained from the automobile via the power plug 24 is converted by the converting device 25 into the direct current power having the voltage suitable to charge the mobile phone and the bluetooth earset, led to the input socket 21 at the bottom of the earset stand via the conducting wire 26 and the input plug 22′, and then, parallel to the pair of electrical contacts 20, led into a converting device 18 in a back plate 49 of the phone holder portion via the conducting wires 108 inside the plastics articles thereby to be converted into an AC power (alternating current power), the voltage of which is determined by the concrete manufacturing condition. Thereafter, the alternating current power flows into a primary coil 40 wound outside a core portion 38 on one end of a primary magnet in the back plate to generate a magnetic flux, and the other end opposite to the core portion 38 of the primary magnet is a plate portion 46 with an enlarged sectional area which is kept close to an inner surface of a front wall of the back plate 49 of the phone holder portion. In charging, a rear wall of a mobile phone 39′ is kept close to the front wall of the back plate (as indicated by a dot-dash line 112). A portion 46′ with an enlarged sectional area of a secondary magnet is kept close to an inner surface of the rear wall of the mobile phone 39′ to receive the magnetic flux so that a secondary coil 41 wound outside a core portion 38′ of the secondary magnet is caused to generate an alternating current power and then direct current power having the voltage suitable to charge the mobile phone, e.g. 5V DC, is obtained by a rectifier 19 in the mobile phone 39′ to charge the battery in the mobile phone. A dotted line (in broken line form) 109 in FIG. 8(a) indicates that the left and lower parts (other than the power plug 24 and the converting device 25) with respect to the dotted line are provided in the back plate 49 of the phone holder portion and the right and upper parts with respect to the dotted line are provided in the mobile phone 39′.

To be charged with this method, the mobile phone 39′ is required to be designed specially, that is, the above described additional components including the secondary magnet 38′ and 46′, the secondary coil 41 and the rectifier 19 must be additionally provided in the mobile phone 39′.

The plate portion 46 with an enlarged sectional area of the primary magnet and the portion 46′ with an enlarged sectional area of the secondary magnet play a role in two aspects: one aspect is that the area in which the magnetic flux passes through a reluctance formed by the front wall of the back plate of the phone holder portion and the rear wall of the mobile phone (generally, both of them are made of plastics materials) is increased to improve efficiency; and the other aspect is that if secondary magnets and secondary coils in different mobile phones are provided at different positions, the secondary magnet in the mobile phone can always be aligned with the primary magnet in the back plate of the phone holder portion in charging to receive the magnetic flux.

The plate portion with an enlarged sectional area located on the other end of the primary magnet shown in the figures may be designed to have more than one (for example, 2˜10) core portions of the primary magnet, and more than one set (for example, 2˜10 sets) of primary coil can be wound around the core portions correspondingly. In this way, the primary magnet can provide a stronger magnetic flux so that the charging efficiency is improved. This alternative mode concretely depends on the requirement of the electrical design and whether the space within the back plate has an enough capacity (not shown).

### Fifth Embodiment

When the mobile phone to be held has various additional functions such as music, television and GPS navigation in addition to the talk function, the holder for the mobile phone and the bluetooth earset of the invention may have a series of additional functions to facilitate use.

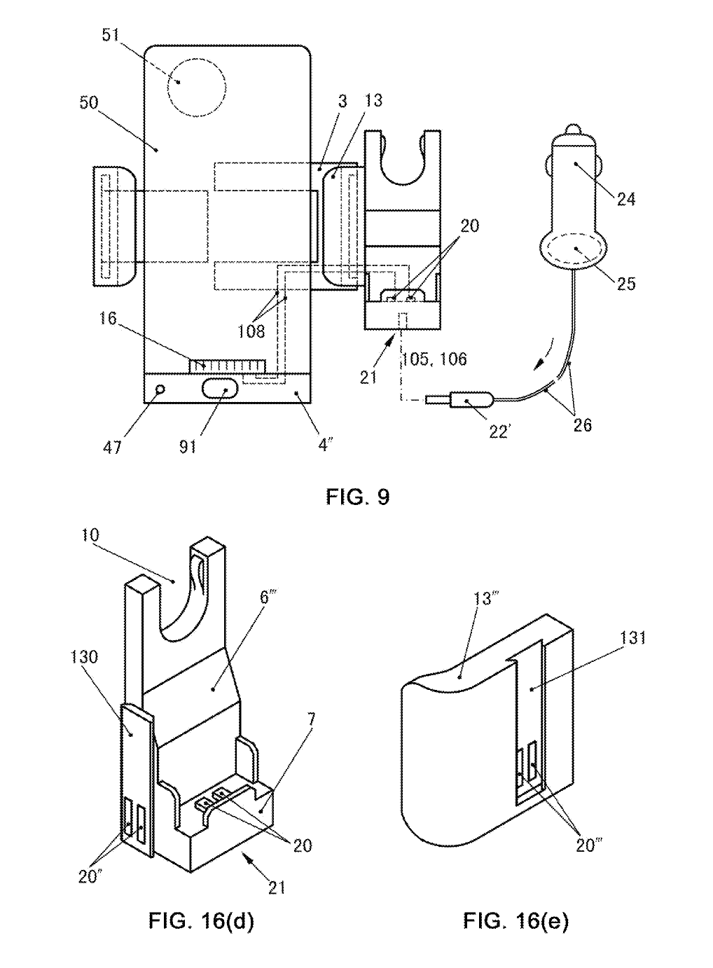

The present embodiment is shown in FIG. 9. For example, on the basis of the third embodiment (see FIG. 6(a)) (may also be based on other embodiments, for example, on the basis of the first embodiment shown in FIG. 3(a) or 4(a), or on the basis of the fourth embodiment shown in FIG. 8(b)), the original back plate 2, 2′, or 49 is increased in its height into a back plate 50 in which a mini loud speaker 51 as well as the corresponding circuit and unit are provided to play back the voice received in the mobile phone. In the meanwhile, a microphone 47 is provided to send the voice of the user of the mobile phone to the counterpart of the talk. A reference numeral 91 denotes a switch button for the mini loud speaker 51 and the microphone 47.

In FIG. 9, the loud speaker and the microphone are provided in a location near to an upper end of the back plate 50 of the phone holder portion and in a bottom member 4″ of the phone holder portion respectively. Actually, other positions are also possible, for example, both of the loud speaker and the microphone are provided in locations near to the upper end of the back plate of the phone holder portion or they are provided in a lower portion of the back plate and in the bottom member of the phone holder portion respectively (not shown). Other reference numerals in FIG. 9 denote the same components as those described above.

### Sixth Embodiment

As shown in FIG. 10, for example, on the basis of the third embodiment (see FIG. 6(a)) (or on the basis of the first embodiment shown in FIG. 3(a) or 4(a), or on the basis of the fourth embodiment shown in FIG. 8(b)), the original back plate 2, 2′, or 49 is increased in its height into a back plate 50′ in which a FM (frequency modulation) transmitter 54 is provided to transmit music information stored in a local mobile phone (or the voice of the counterpart of the talk, or music information stored in a mobile phone of the counterpart of the talk) out in a wireless FM manner. A dotted line 115 indicates that a FM wave is transmitted out, received by an antenna of an audio equipment in the automobile in a short distance, and played back by a high quality loud speaker in the automobile. A reference numeral 55 in the figure denotes a number of operating buttons of the transmitter 54. In the meanwhile, the microphone 47 is provided to send the voice of the user of the mobile phone to the counterpart of the talk.

A reference numeral 52 in FIG. 10 denotes an audio output socket to be connected to an audio power amplifier stage of the mobile phone, and a numeral 52′ denotes a plug corresponding to the audio output socket which is to be inserted into the audio output socket 52 as indicated by a dot-dash line 114. The plug 52′ is connected to a power amplifier stage of the audio equipment in the automobile via a conducting wire 53 in a wired manner, and music information stored in the local mobile phone or the voice of the counterpart of the talk or music information stored in the mobile phone of the counterpart of the talk is played back by the high quality loud speaker in the automobile. Other reference numerals in FIG. 10 denote the same components as those described above.

If FM is utilized to transmit and receive a signal, on one hand, it is required to tune and select a frequency, on the other hand, fidelity of tone quality is apt to be decreased, however, the user need not to detach the audio equipment in the automobile to avoid work complexity. The above problem can be avoided in a wired manner, however, it is required to detach the audio equipment in the automobile in provision, which is complicated. Therefore, both of the wired and wireless manners can be provided for different product designs to choose. Then, optional modes which may be chosen by the user of a concrete product arrangement are: (1) only the audio output socket 52 and the microphone 47 are provided; (2) only the FM transmitter 54 and the microphone 47 are provided; (3) all of three devices of the audio output socket 52, the microphone 47 and the FM transmitter 54 are provided; and (4) all of four devices of the audio output socket 52, the microphone 47, the FM transmitter 54 and the mini loud speaker 51 are provided (this option is shown in FIG. 10).

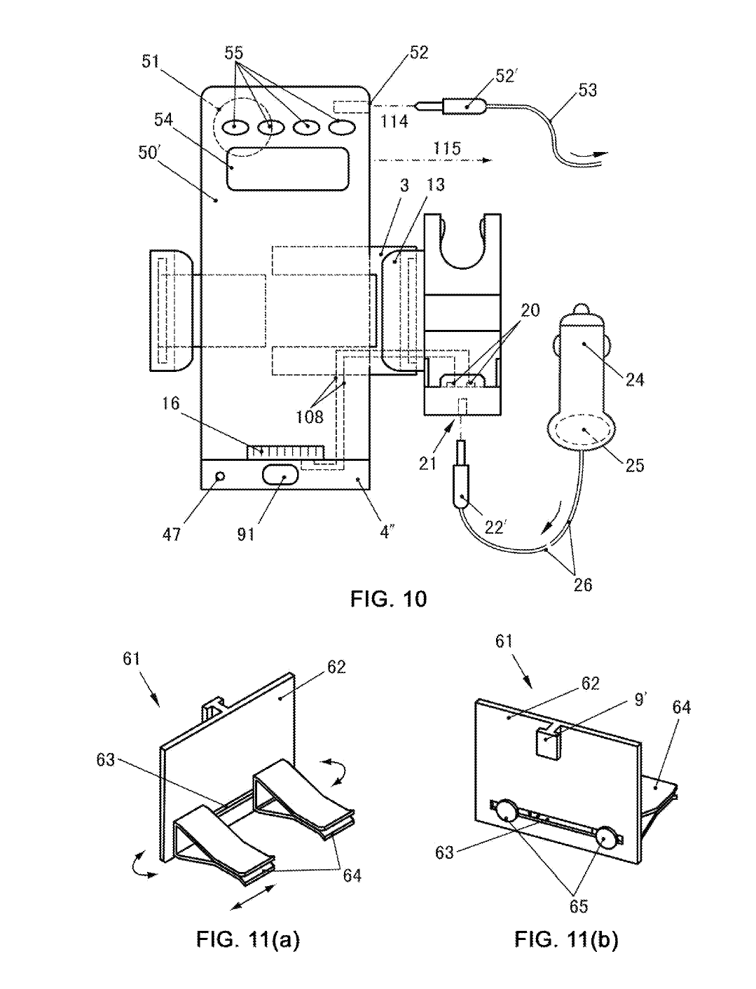

FIGS. 11(a) and 11(b) show a fixing plate 61 for fixing the various holders for the mobile phone and the bluetooth earset of the invention in an automobile. The fixing plate 61 has a main plate 62 in which one slot 63 with a certain length is provided in a horizontal direction, a pair of fixing clips 64 are fixed to the slot 63 with two rivets or screws 65, and then the pair of fixing clips 64 can be held to blades of an air outlet of an air conditioner in the automobile. The pair of fixing clips 64 are movable in the left-right direction as shown by a bidirectional arrow in FIG. 11(a) to accommodate to positions of the blades. The fixing clips 64 are also rotatable as shown by a bidirectional arched arrow in the figure, that is, they are also suitable to be held to the vertically arranged blades of the air outlet if they are rotated to a vertical orientation and are suitable to be held to the horizontally arranged blades of the air outlet if they are rotated to a horizontal orientation. A reference numeral 9′ denotes a fixing button, and the fixing button 9′ can be fitted in an embedded manner with the holding cavity 9 in the back surface of the back plate of the phone holder portion in the embodiments described above so that the whole holder for holding and charging the mobile phone and the bluetooth earset can be fixed to the air outlet of the air conditioner in the automobile.

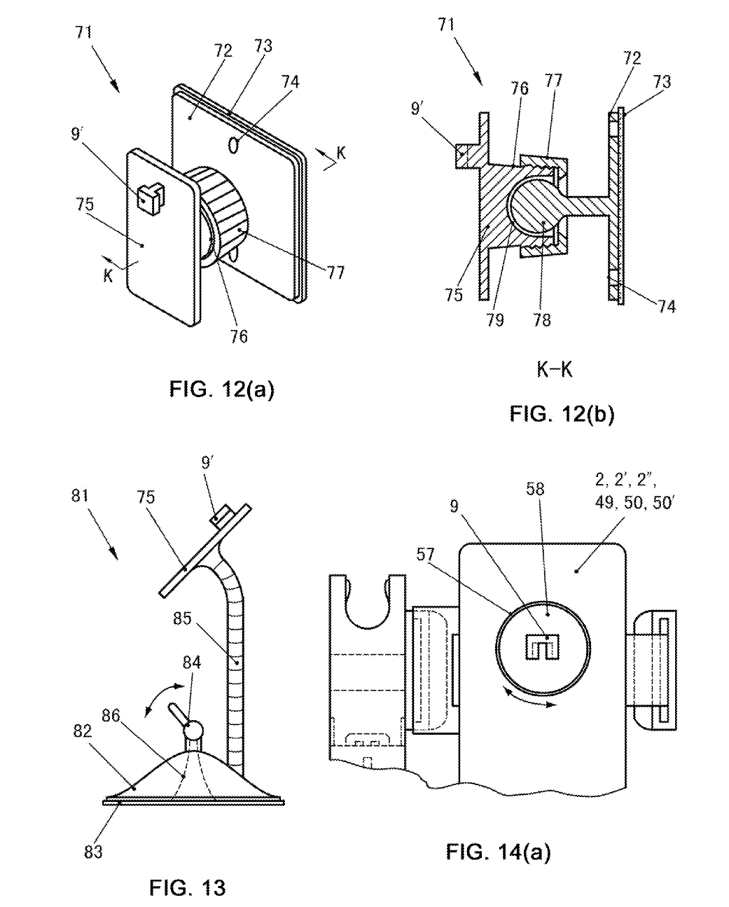

FIGS. 12(a) and 12(b) (FIG. 12(b) is a K-K sectional view in FIG. 12(a)) show a ball-socket universal joint type fixing device 71 for fixing. A reference numeral 72 denotes a base plate of the fixing device 71, and a double-sided adhesive tape 73 is stuck to a rear surface of the base plate for adhering and fixing the base plate to a certain flat surface such as a surface of an instrument panel in the automobile. The base plate 72 is provided with standby screw holes 74 for screw fixation or tie fastening, the number and the position of which can be altered according to different designs and arrangements. A reference numeral 75 denotes a front fixing plate, and the fixing button 9′ is provided on a surface of the front fixing plate 75 to be fitted in an embedded manner with the holding cavity 9 in the back surface of the back plate of the phone holder portion in the embodiments described above so that the whole holder for holding and charging the mobile phone and the bluetooth earset can be fixed. A reference numeral 78 denotes a ball which is formed integrally with the base plate 72, a numeral 79 denotes a socket which is formed integrally with the front fixing plate 75, a numeral 76 denotes outer threads of the socket, and a numeral 77 denotes a nut for fastening. These figures show that the base plate 72 is formed integrally with the ball 78 and the front fixing plate 75 is formed integrally with the socket 79, however, it is also possible if they are reversed, that is, the front fixing plate is formed integrally with the ball and the base plate is formed integrally with the socket (not shown).

FIG. 13 shows a suction cup type fixing device 81 for fixing the whole holder to a glass surface or other smooth surfaces in the automobile. A reference numeral 82 denotes a base shell, a numeral 83 denotes a suction cup sheet made of soft plastics, a numeral 84 denotes a raising lever for raising the suction cup sheet 83 to produce a vacuum attraction, a numeral 86 denotes a pulling bar connecting the suction cup sheet 83 to the raising lever 84, and a numeral 85 denotes a corrugated tube (stem) which is bendable and can be held desirably with the angle and orientation formed by being bent. As described above, the reference numeral 75 denotes the front fixing plate, and the numeral 9′ denotes the fixing button to be fitted in an embedded manner with the holding cavity 9 in the back plate of the phone holder portion so that the whole holder can be fixed at a proper location in the automobile with the desired angle and orientation.

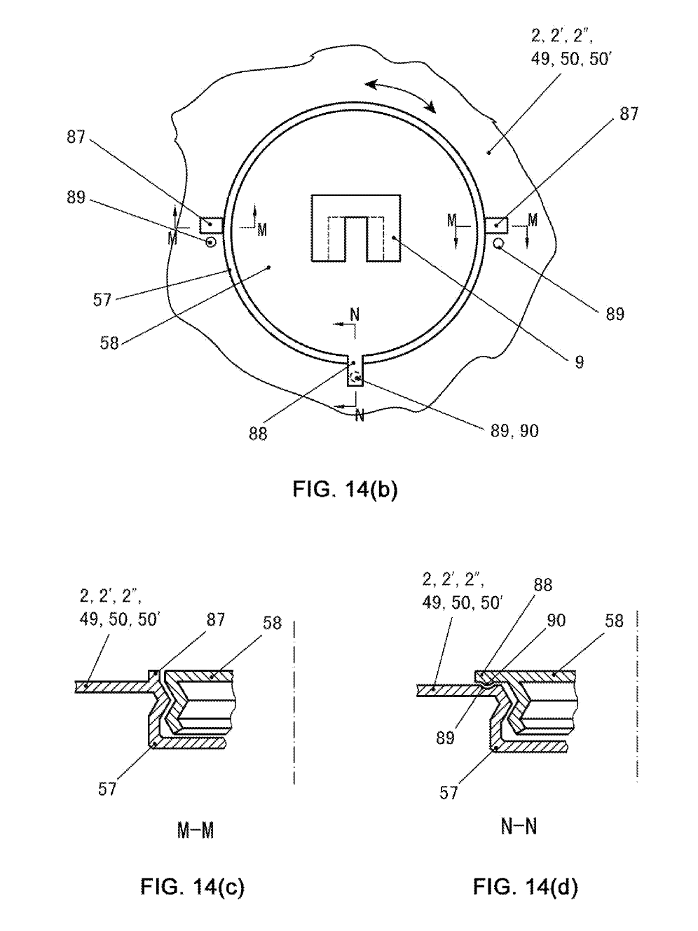

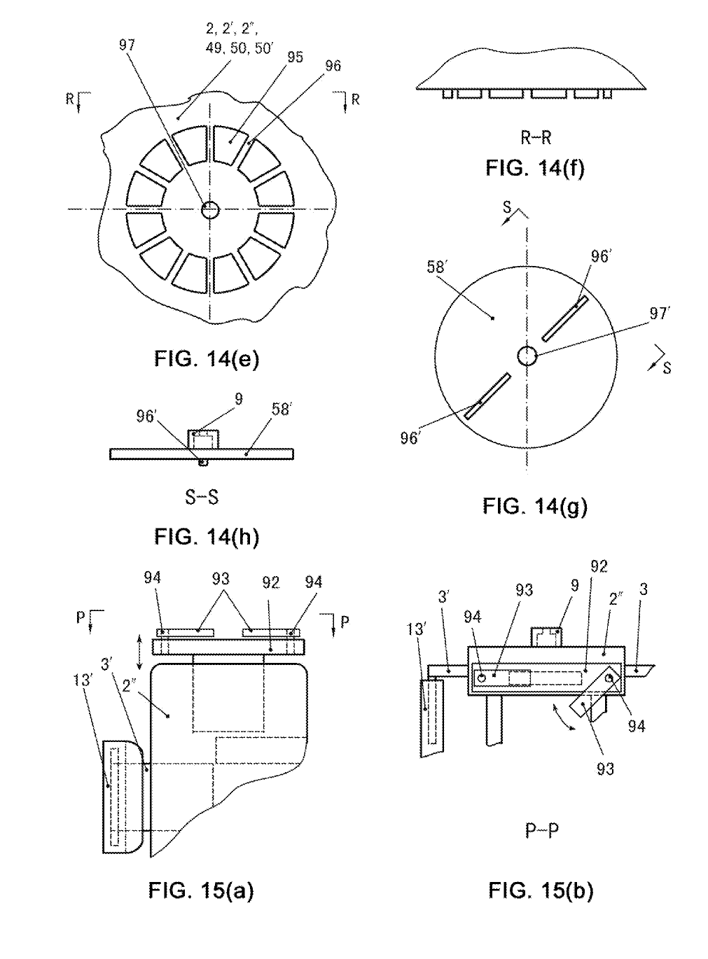

FIG. 14(a) shows the back surface of the holder for the mobile phone and the bluetooth earset of the invention. In the above described embodiments, the back plates with different forms of the phone holder portion are indicated by the reference numerals 2, 2′, 2″, 49, 50 and 50′. There is the holding cavity 9 in the back surface of each of these back plates, and the holding cavity 9 is fitted in an embedded manner with the fixing button 9′ of the various fixing devices described above so that the back plates are fixed. In contrast, a round recess 57 is provided in the back surface of the back plate of the phone holder portion in the present embodiment, and a round disk 58 is seated into the round recess 57 in a sliding-fitted-in (imbedded) assembling manner of a plastics article, seized without escape and can be rotated with respect to the round recess 57 as shown by a bidirectional arched arrow in the figure. A holding cavity 9 is provided in an outer surface of the round disk 58 as the holding cavity in the back surface of the back plate of the phone holder portion. Recently, mobile phones of various types available in the market have display screens with such functions as GPS satellite navigation display and TV program display. However, the usual mobile phones are vertical (erective) type and the display screens of these mobile phones are held vertically in a normal condition so as not to conform with the visual habit while a television screen is being viewed. The structure of the present embodiment has such an effect that the above mentioned device can be used to rotate the whole holder holding the mobile phone (and the bluetooth earset) so that the screen of the phone is held horizontally to facilitate the viewing.

In addition, position (or angle) limiting stop spots can be provided at proper locations of the round recess 57 and the round disk 58. As shown in FIGS. 14(b) to 14(d), two stop tabs 87 and two or three or more recessed spots 89 are provided at an edge of the round recess 57, and on the periphery of the round disk 58 is provided one protruding tab 88 under which one protruding spot 90 is provided. The user can easily position the mobile phone in place by pulling the round disk 58 once, that is, for example, the round disk 58 is rotated clockwise to its extremity to achieve the horizontal orientation of the mobile phone, and the round disk 58 is rotated counterclockwise to its extremity to achieve the vertical orientation of the mobile phone. It is not required to determine whether the angle has satisfied the positioning or not during the rotation. Alternatively, other stop solutions may be employed. As shown in FIG. 14(b), the reference numeral 87 denotes the two stop tabs provided in proper angular positions at the edge of the round recess 57, and the numeral 88 denotes the one protruding tab provided at the edge of the round disk 58. FIGS. 14(c) and 14(d) are a M-M sectional view and a N-N sectional view in FIG. 14(b) respectively and show an example of the configuration in FIG. 14(b). In assembling, the protruding tab 88 is provided between the two stop tabs 87. It can be understood how a rotational angle is limited in connection with the above figures. The structure shown in the above figures is just an example, and a variety of alternative structures are possible (not shown one by one).

FIGS. 14(e) to 14(h) show another alternative mode. The above mentioned round recess 57 is changed into a round raised disk 95, and the round raised disk 95 may be in the form of an integral circle or concentric circles shown in the figures and is divided by a number of (for example, 6˜50) radial recessed grooves 96 into many (for example, 6˜100) small raised blocks. On an inner surface of a round disk 58′ is provided one raised slab 96′ which coincides with a diameter of the round disk and the shape and the size of which match with those of the recessed grooves 96. When the inner surface of the round disk 58′ is kept close to the round raised disk 95, they can be fixed by a screw passing through holes 97 and 97′. If the round disk 58′ is rotated, the raised slab 96′ is embedded or not embedded in the recessed grooves 96 so that the round disk 58′ can be rotated to or stopped at a desired angle. A holding cavity 9 is provided in an outer surface of the round disk 58′ as the holding cavity in the back surface of the back plate of the phone holder portion. FIGS. 14(f) and 14(h) are a R-R view in FIG. 14(e) and a S-S view in FIG. 14(g) respectively.

When the holder is rotated as described above to accommodate to the habit of watching TV, the mobile phone held on the holder will be thrown out due to a centrifugal force while the automobile is turning a corner. FIGS. 15(a) and 15(b) show an example to solve this problem. As shown in the figures, an upper stopping bar 92 is provided at the top of the back plate 2″ of the phone holder portion, and the upper stopping bar 92 can be pulled out/retracted from/to the interior of the back plate in the up-down direction (something like the holding arms). Axles 94 and upper stopping tabs 93 (here, the number of each of them is two, another number is possible but not shown) are provided to the upper stopping bar 92. The mobile phone can be fastened and will not be thrown out horizontally after the upper stopping tabs 93 are turned forward (as shown by a bidirectional arched arrow in FIG. 15(b)) and then the upper stopping bar 92 along with the upper stopping tabs 93 are moved downward (as shown by a bidirectional arrow in FIG. 15(a)).

If such modes as shown in FIGS. 6(a) and 6(b), FIGS. 7(a) and 7(b), FIG. 9 and FIG. 10 are employed, when the input socket of the mobile phone is inserted by the input in-line multiple plug 16 of the phone holder portion, the rear surface of the mobile phone is not necessarily kept close to the front surface of the back plate of the phone holder portion exactly. FIG. 17 shows an example to solve this problem. A center hole 122 with inner threads 121 is opened in the back plate 2, 2′, 2″, 49, 50 or 50′ of the phone holder portion, and the center hole 122 is provided with a recess portion 123 with an enlarged section which provides a finger operating space at a location near to the rear surface of the back plate. A front forcing screw 124 has outer threads 125 to be fitted with the inner threads 121, and the front forcing screw 124 is provided with a center tip 126 with a radial recess on one end thereof and a manual knob 127 on the other end thereof. The manual knob 127 is provided with a linear/cross groove 128 facing outward to receive a screw driver. The front forcing screw 124 is screwed into the center hole 122 (by engaging the threads 125 and the threads 121) to expose the center tip 126, the center tip 126 passes through a compensating plate 98 opened with a stepped hole 99, and a riding hole 126′ of a fixing key 100 clips on the radial recess of the center tip 126. When the manual knob 127 is rotated, the front forcing screw 124 is moved in the front-rear direction together with the compensating plate 98, and the compensating plate 98 neither comes away nor is rotated following the manual knob 127 so that the aim of keeping the rear surface of the mobile phone close to the front surface of the back plate of the phone holder portion exactly can be attained.

In the above embodiments, the left or right holding arm or the left or right extension arm, the bottom member and the bottom legs, and the upper stopping bar and the upper stopping tabs of the phone holder portion are drawable and retractable. In order to realize the slidable positioning, for example, a rack may be provided on one of two sliding surfaces (the orientation of teeth of the rack is perpendicular to the moving direction thereof), and a protruding tip which can be ejected and retracted is provided on the other surface. Usually, the protruding tip butts against the root of a tooth to be positioned, and the protruding tip can be pushed away by the top of the tooth and slide to the next tooth while sliding with respect to the rack. Similar ways may be deduced by analogy (such a configuration is not shown).

When it is required to lead power (inside the plastics articles) across the gaps between the back plate of the phone holder portion and the left or right holding arm which slide with respect to each other, there may be a variety of methods. For example, (1) a helical conducting wire is used to accommodate to extension and retraction thereof; or (2) a conducting slide rail is provided on one of the two sliding surfaces and a conducting contact is provided on the other surface so that the slide rail and the conducting contact can be electrically connected while they are sliding with respect to each other (these configurations are not shown).

In the above detailed explanation of the present invention, the involved concrete electrical, electronics and communication technologies themselves are the prior art, thus can be excluded from the scope claimed by the present invention.

1. A holder for holding and charging a mobile phone and a bluetooth earset, comprising:
a phone holder portion
including a back plate, a left holding arm and a right holding arm attached to the back plate, a left extension arm and a right extension arm which are extendable/retractable from/to the left and right holding arms in a front-rear direction respectively, a bottom member and bottom legs, at least one of the left and right holding arms being drawable/retractable from/to the back plate in a left-right direction,
an earset stand portion including an earset stand back plate, an earset stand bottom piece, a rim plate for positioning a lower end of the bluetooth earset, and a holding device for positioning an upper end of the bluetooth earset, said holding device further including a holding opening and a spring holding clip, the earset stand portion being attached to the left or right holding arm or the left or right extension arm thereof in an integral or split manner,
a holding cavity provided in a back surface of the back plate for fixing the holder,
a plug used to receive power from an automobile, and
a converting device which converts the received power into a direct current power having a voltage to charge the mobile phone and the bluetooth earset, the direct current power being divided into two ways connected to each other in parallel for charging the mobile phone and bluetooth earset.

2. The holder of claim 1, wherein
a conducting wire device for power in charging the mobile phone has a plurality of forms, the conducting wire device being provided on one end thereof with an output plug for leading out power from an output socket and is provided on the other end thereof with various input plugs for mobile phones of different styles, or said conducting wire device being led to another plug to be inserted directly into a charging socket of the mobile phone via a conducting wire provided inside plastics articles of the holder.

3. (canceled)

4. The holder of claim 1, wherein
the direct current power is divided into two ways connected to each other in parallel by a dispensing block, on one end of the dispensing block is provided an input plug inserted into an input socket which is provided in the bottom piece of the earset stand portion or in the back plate of the phone holder portion, and on the other end of the dispensing block are provided an input socket which has the direct current power with the voltage to charge the mobile phone and the bluetooth earset, and an output socket connected to the input socket parallelly into which an output plug on one end of a conducting wire device for charging the mobile phone or the bluetooth earset is to be inserted.

5. The holder of claim 4, wherein
the dispensing block is attached to the bottom piece of the earset stand portion or the back plate of the phone holder in a split manner, or combined integrally with the bottom piece or the back plate in an integral manner.

6-9. (canceled)

10. The holder of claim 1, wherein
the bottom member and the bottom legs are combined into a fixed bottom plate, and
a plug to be inserted directly into a charging socket of the mobile phone is provided on the bottom plate.

11. The holder of claim 1, wherein
a plug to be inserted directly into a charging socket of the mobile phone is provided on an inner side of the left or right holding arm or either of the extension arms thereof of the back plate.

12. The holder of claim 1, wherein
when the earset stand portion is attached to the left or right holding arm or the left or right extension arm thereof of the back plate in the split manner,
a fixing head provided on the earset stand is inserted into a fixing cavity provided in either of the holding arms or either of the extension arms, and
a pair of electrical sockets and a pair of electrical plugs used to lead power connecting are provided in the fixing head and fixing cavity respectively.

13. The holder of claim 1, wherein
when the earset stand portion is attached to the left or right holding arm or the left or right extension arm thereof of the back plate in the split manner,
an inserting plate with a trapezoidal cross-section is provided on a side surface of the earset stand,
a receiving groove the shape and size of which match those of the inserting plate is provided in an outer surface of either of the holding arms or either of the extension arms, and
a pair of electrical contacts capable of conducting power provided on a surface facing outward of each of the inserting plate and receiving groove, the shapes, sizes and positions of the two pairs of electrical contacts matching each other.

14. (canceled)

15. The holder of claim 1, wherein
the mobile phone is charged wirelessly so that after power led out from the automobile is converted into the direct current power having voltage to charge the mobile phone and bluetooth earset, power for charging the mobile phone is led into the back plate for conversion into an alternating current power by a converting device provided in the back plate,
the converting device is connected to a primary coil wound outside a core portion on one end of a primary magnet in the back plate so that a magnetic flux is generated in the primary magnet, and
the other end of the primary magnet is a plate portion with an enlarged sectional area which is kept close to an inner surface of a front wall of the back plate;
in charging, an outer surface of a rear wall of the mobile phone is kept close to an outer surface of the front wall of the back plate,
a secondary magnet in the mobile phone which is kept close to the rear wall of the mobile phone receives the magnetic flux so that a secondary coil wound outside a core portion of the secondary magnet generates alternating current power, and
then direct current power having voltage to charge the mobile phone is obtained by a rectifier in the mobile phone to charge the mobile phone.

16. The holder of claim 15, wherein
the plate portion with an enlarged sectional area located on the other end of the primary magnet has more than one core portion of the primary magnet, and more than one set of primary coils are wound around corresponding core portions.

17. The holder of claim 4, wherein
in addition to electrical contacts for charging, each of the plug and the socket has electrical contacts for information communication, the holder further comprising:
a loud speaker in the back plate for playing back the voice received in the mobile phone, and
a microphone in the back plate for sending the voice of the user of the mobile phone.

18-19. (canceled)

20. The holder claim 17, wherein the back plate further includes:
a socket to be connected to an audio power amplifier stage of the mobile phone and a microphone for sending the voice of the user of the mobile phone, and music information stored in the local mobile phone or the voice of the counterpart of the talk received by the local mobile phone or music information stored in the mobile phone of the counterpart of the talk is led to an audio power amplifier stage of an audio equipment in the automobile via the socket in the a wired manner and played back by a loud speaker in the automobile; and
a FM transmitter and a microphone for sending the voice of the user of the mobile phone, and music information stored in the local mobile phone or the voice of the counterpart of the talk received by the local mobile phone or music information stored in the mobile phone of the counterpart of the talk is transmitted out in a wireless FM manner, received by the audio equipment in the automobile in a short distance and played back by the loud speaker in the automobile.

21-23. (canceled)

24. The holder of claim 1, wherein
the holder is attached with a fixing plate which fixes the holder to blades of an air outlet of an air conditioner in the automobile, the fixing plate having a fixing button matchable with the holding cavity in the back surface of the back plate, a slot, and a pair of fixing clips provided to the slot, said clips movable along and rotatable in the slot.

25. The holder of claim 1, wherein
the holder is attached with a ball-socket universal joint type fixing device which fixes the holder to a surface in the automobile, the fixing device having a base plate on one side of which a double sided adhesive tape is adhered, and on the other side of which a ball of a universal joint and a socket fitted in an embedded manner with the ball are provided, the base plate provided with standby holes for screw fixation or tie fastening, the socket being formed integrally with a front fixing plate, with a fixing button matchable to the holding cavity being provided on a surface facing outward from the front fixing plate.

26. The holder of claim 1, wherein
the holder is attached with a suction cup type fixing device which fixes the holder to a glass or other smooth surface in the automobile, the fixing device having a base shell, a suction cup sheet made of soft plastics, a pulling bar, a raising lever, a corrugated tube, and a front fixing plate, with a fixing button matchable to the holding cavity being provided on a surface facing outward from the front fixing plate.

27. The holder of claim 1, wherein
one of a round recess and a round raised disk is formed on the back surface of the back plate, and a round disk the size and shape of which match those of the round recess or raised disk is seized in the round recess or fitted with the raised disk in a sliding-fitted-in assembling manner or a screw assembling manner;
the round disk rotatable with respect to the round recess or raised disk without escape, and
the holding cavity being provided in an outer surface of the round disk.

28-30. (canceled)

31. The holder of claim 1, wherein
an upper stopping bar which is drawable and retractable in an up-down direction is provided at the top of the back plate for fixing the mobile phone within the holder, and vertical axles and upper stopping tabs which are held by the axles and can be rotated out and rotated back horizontally are provided at positions near to both ends of the upper stopping bar.

32. The holder of claim 1, wherein
the back plate is opened with a center hole with inner threads which extends through the back plate, the center hole having a recess portion with an enlarged section at a location near to the back surface of the back plate,
a compensating plate opened with a stepped hole is provided in front of the back plate,
a front forcing screw which has outer threads to be fitted with the inner threads is screwed into the center hole;
the front forcing screw is provided with a center tip with a radial recess on a front end thereof and a manual knob on a rear end thereof, the manual knob having a linear/cross groove facing outward to receive a screw driver, and
the radial recess of the center tip and the stepped hole of the compensating plate match with a fixing key.

33. (canceled)

34. A method for holding and charging a mobile phone and a bluetooth earset, comprising:
preparing a holder for holding and charging a mobile phone and a bluetooth earset;
holding the mobile phone in the holder;
leading direct current power having a voltage suitable to charge the mobile phone and the bluetooth earset into an input socket on a lower end of a dispensing block,
inserting an input plug on an upper end of the dispensing block into an input socket at the bottom of an earset stand, then
leading direct current power parallel to the power fed to the earset stand into an input socket at the bottom of the mobile phone from the bottom of the dispensing block, thereby to charge the mobile phone; and
putting the bluetooth earset in the earset stand to charge a battery in the bluetooth earset.

35. A method for charging a mobile phone in a wireless manner, comprising:
preparing a holder for holding and charging a mobile phone and a bluetooth earset, wherein devices for charging the mobile phone are operated in the wireless manner;
placing the mobile phone adapted to be charged in the wireless manner in a phone holder portion,
keeping an outer surface of a rear wall of the mobile phone close to an outer surface of a front wall of a back plate of the phone holder portion; and
after power led out from an automobile is converted into direct current power having a voltage to charge the mobile phone and the bluetooth earset,
leading power in the way for charging the mobile phone into the back plate of the phone holder portion thereby to convert it into alternating current power by a converting device provided in the back plate,
wherein the alternating current power is led to a primary coil wound outside a primary magnet in the back plate so that a magnetic flux is generated in the primary magnet, thus a secondary magnet in the mobile phone receives the magnetic flux so that a secondary coil wound outside the secondary magnet is caused to generate alternating current power and then direct current power having a voltage to charge the mobile phone is obtained by a rectifier in the mobile phone to charge the mobile phone.
